(19) United States
(12) Patent Application Publication
(10) Pub. No.: US 2007/0039138 A1
(43) Pub. Date: Feb. 22, 2007

(54) Retaining device

(76) Inventor: Rickard Nicholas Graham, Mistley (GB)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(21) Appl. No.: 11/503,763

(22) Filed: Aug. 14, 2006

(30) Foreign Application Priority Data
Aug. 16, 2005 (GB) 0516756.4

(51) Int. Cl. F16G 11/00

(52) U.S. Cl. 24/129 R

(57) ABSTRACT

The invention relates to a retaining device that includes a first retaining means (20), a second retaining means (30) and first and second extension means (40,42). The first retaining means (20) is coupled to the second retaining means (30) and the second retaining means is coupled to the first and second extension means (40,42) such that a linear member such as a rope or line may be secured to the second retaining means.

### BACKGROUND

The present invention relates to a retaining device and specifically to a retaining device that enables a line or rope to be secured quickly and simply.

A great number of different knots and devices such as blocks and pulleys have been used to secure ropes or lines or to secure items with such a rope whilst maintaining tension on the rope or line. In spite of the extensive effort in this field of endeavour, there does not exist a retaining device that enables a rope or a line to be quickly and securely retained whilst allowing the rope to be removed from the retaining device in a quick and simple manner which controls the release of tension in the rope.

### SUMMARY OF THE INVENTION

According to the present invention there is provided a retaining device comprising a first retaining means, a second retaining means and first and second extension means, the first retaining means being coupled to the second retaining means and the second retaining means being coupled to the first and second extension means such that a linear member may be secured to the second extension means.

In one embodiment, the first retaining means and the second retaining means are arranged so as to define a first plane and the linear member is arranged to be parallel to the first plane but not coincident with the first plane. Alternatively, the first retaining means and the second retaining means are arranged so as to define a first plane and the linear member is arranged to be coincident with the first plane.

The first retaining means defines a first area and the second retaining means defines a second area, the first and/or the second area may having a substantially circular, oval square or rectangular shape. Furthermore, a first axis may pass through the centre of the first area and the second area and a second axis may pass through the first and second extension means, the first axis being substantially perpendicular to the second axis.

In one embodiment, the first extension means is coupled to one side of the second retaining means and the second extension means is coupled to the other side of the second retaining means. Alternatively, an extension member comprises the first and second extension means.

### BRIEF DESCRIPTION OF THE DRAWINGS

FIG. 1a-1d show multiple schematic depictions of a device according to the present invention; and

FIGS. 2a-2c show a schematic depiction of a device according to the present invention when in use.

### DETAILED DESCRIPTION

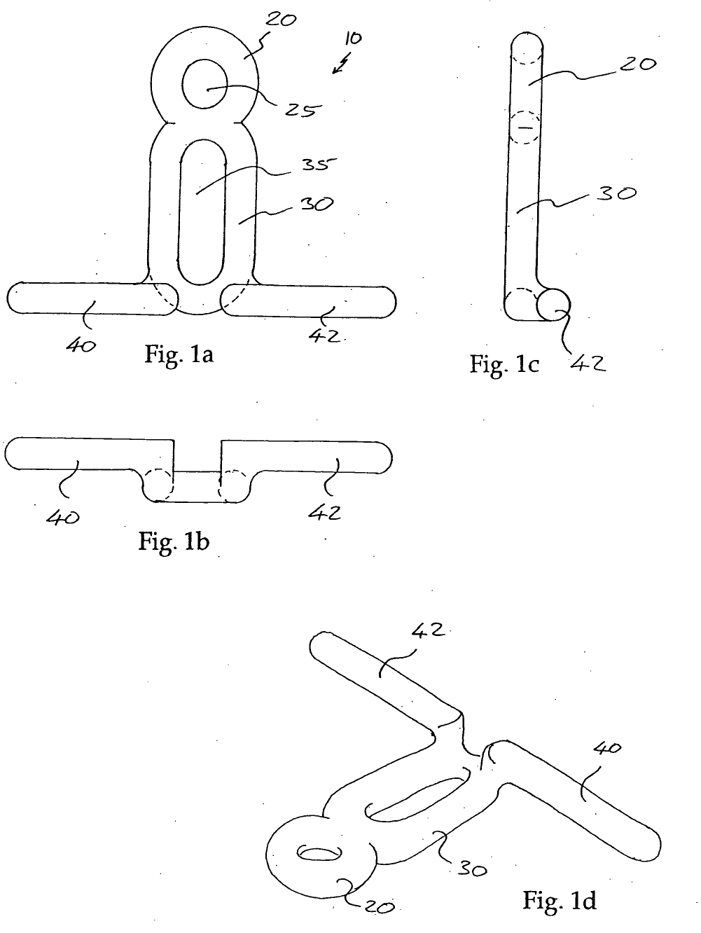

FIG. 1 shows a schematic depiction of a device 10 according to the present invention: FIG. 1a shows a front view of the device; FIG. 1b shows an underside view of the device; FIG. 1c shows a side view of the device and FIG. 1d shows a perspective view of the device. The device 10 comprises a first retaining means 20 defining a first area 25 and a second retaining means 30 defining a second area 35: the first retaining means 20 and the second retaining means 30 are joined together to form a retaining member. Connected to the retaining member and to the second retaining means 30 are first and second arms 40, 42. The retaining member is configured such that a first axis passes through the centre of the first area and the second area and that this first axis is substantially perpendicular to a second axis which passes through the first and second arms.

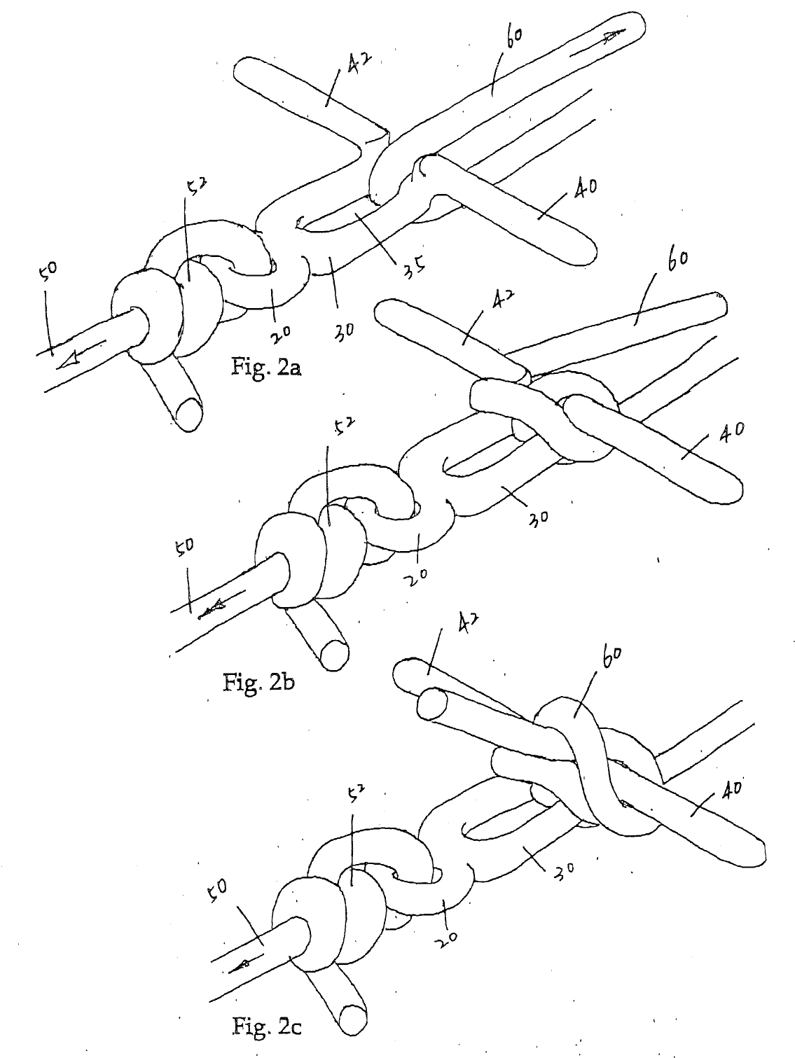

FIG. 2 shows a schematic depiction of a device according to the present invention when in use. FIG. 2a shows that a first rope or line 50 has been inserted into the first area defined by the first retaining means and that a simple knot 52 has been made to secure the first rope to the device. The first rope is secured at its other end. It should be understood that the first rope may be connected to the device by means other than a knot. Furthermore, the first retaining means may be secured by means other than a rope, for example, being secured on a mounted ring.

In FIG. 2a a second rope 60 is passed through the second area defined by the second retaining means; FIG. 2b shows that the second ropes is then looped round the first arm, passed over the second retaining means and then looped around the second arm; and FIG. 2c shows that the rope is secured by passing the end around the first arm and then between the rope and the second retaining means. It should be noted that the first retaining loop is capable of execution with the rope under tension and that this first loop is then capable of taking any strain in the rope or ropes whilst subsequent turns and hitches are made to secure the rope, to achieve this it is necessary for the first and second extension to be perpendicular to the rope or line. The contact area between the second rope and the second retaining means, the first arm and the second arm is sufficient to create a relatively large frictional force such that the second rope is retained by the retaining device. This secure retention is provided despite it being a very simple process to remove the rope from the device without losing control of the tension in the system, adjust the rope if required, and to subsequently re-attach the rope to the device.

It will be immediately understood that the present invention encompasses a very broad range of modifications to the specific design described above with reference to FIGS. 1 and 2. For example, the Figures show that the second area is larger than the first area and that the second area has a substantially oval shape as opposed to the substantially circular shape of the first area. This is to enable a loop of rope to be passed through the second area, but it will be understood that both of the first and second areas may have a substantially circular or oval shape. It will be understood that square or rectangular shapes may be used for the first and second areas but that the corners should be rounded off to reduce the risk that the rope is frayed or damaged by the device. It should also be understood that the first retaining means may be replaced with a configuration that is more suited to specific tasks such as, for example, attachment to netting, webbing, tarpaulin, etc. It will be understood that this list is not exhaustive and should not be seen as limiting the scope of the present invention.

Although the first and second arms are shown as being offset from the plane defined by the first and second retaining means it will be understood that the first and second arms may alternatively be provided in the same plane as the first and second retaining means. Also, the first and second arms may be comprised by a single arm that is coupled to the second retaining means.

The size of the retaining device will be determined by the application for which the retaining device is to be used. For example, at the largest end of the scale it is believed that a 12 mm diameter rope is the largest that may be used effectively with the device. In this case the device may be used in a maritime application, for example, securing a yacht anchor, or for securing a tarpaulin or similar over the open load area of a lorry trailer. In this case, it is believed that for a circular first retaining means the first area may have a diameter of approximately 15 mm and for a circular second retaining means the second area may have a diameter of approximately 15 mm. For an oval second restraining means the second area may have a minor axis of approximately 15 mm and a major axis of between 40-50 mm.

Typically, such a device would be made from steel and be made to have a cross-sectional diameter of 8 mm. It will be understood that other materials may be used and that by forming the device to have a larger cross-sectional diameter then it may be possible to use the device with ropes having a cross-sectional diameter of greater than 12 mm.

At the opposite end of the scale, a device according to the present invention could be used to secure a fragile plant stem or branch to a garden cane (or other support). In such a case, the first and second areas need only be a few millimetres across in order to receive and accommodate a twine or string. It follows from this that it is necessary for such a device to be lightweight to prevent any damage from being caused and thus the device may be formed from a plastics material.

It will be understood that a device according to the present invention may be of use in many other fields than those described above, and may be of almost any size and made from any material suitable for the relevant application. It will be understood that often modification of the device may be made without departing from the teaching of the present invention.

1. A retaining device comprising a first retaining means, a second retaining means and first and second extension means, the first retaining means being coupled to the second retaining means and the second retaining means being coupled to the first and second extension means such that a linear member may be secured to the second retaining means.

2. A retaining device according to claim 1, wherein the first retaining means and the second retaining means are arranged so as to define a first plane and the linear member is arranged to be parallel to the first plane but not coincident with the first plane.

3. A retaining device according to claim 1, wherein the first retaining means and the second retaining means are arranged so as to define a first plane and the linear member is arranged to be coincident with the first plane.

4. A retaining device according to claim 1, wherein the first retaining means defines a first area and the second retaining means defines a second area, the first and/or the second area having a substantially circular shape.

5. A retaining device according to claim 1, wherein the first retaining means defines a first area and the second retaining means defines a second area, the first and/or the second area having a substantially oval shape.

6. A retaining device according to claim 1, wherein the first retaining means defines a first area and the second retaining means defines a second area, the first and/or the second area having a substantially square shape.

7. A retaining device according to claim 1, wherein the first retaining means defines a first area and the second retaining means defines a second area, the first and/or the second area having a substantially rectangular shape.

8. A retaining device according to claim 4, wherein a first axis passes through the centre of the first area and the second area and a second axis passes through the first and second extension means, the first axis being substantially perpendicular to the second axis.

9. A retaining device according to claim 1, wherein the first extension means is coupled to one side of the second retaining means and the second extension means is coupled to the other side of the second retaining means.

10. A retaining device according to claim 1, wherein an extension member comprises the first and second extension means.

11. A retaining device according to claim 1, wherein the retaining device comprises a plastics material.

12. A retaining device according to claim 1, wherein the retaining device comprises a metallic material.
